(19) United States
(12) Patent Application Publication
(10) Pub. No.: US 2022/0314720 A1
(43) Pub. Date: Oct. 6, 2022

(54) AMPHIBIOUS CATERPILLAR VEHICLE

(71) Applicant: Chung Chul LEE, Busan (KR)

(72) Inventors: Chung Chul LEE, Busan (KR); Seung Soo LEE, Busan (KR)

(73) Assignee: Chung Chul LEE, Busan (KR)

(21) Appl. No.: 17/846,745

(22) Filed: Jun. 22, 2022

Related U.S. Application Data
(63) Continuation of application No. PCT/KR2021/000427, filed on Jan. 13, 2021.

(30) Foreign Application Priority Data
Jan. 23, 2020 (KR) 10-2020-0009331

(51) Int. Cl. B60F 3/00; B62D 55/12; B62D 55/26

(52) U.S. Cl. CPC B60F 3/0015; B62D 55/12; B62D 55/26; B60F 3/0038

(57) ABSTRACT

An amphibious caterpillar vehicle includes a central body of a second buoyancy material of a track shoe is disposed between a pair of wheels. An engagement body of the second buoyancy material of the track shoe is inserted into a buoyancy material engagement groove of each of the wheels so that a driving force is transferred from a driving sprocket to a caterpillar track. A coupling force between driving sprockets and track shoes forming a caterpillar track increases so that the caterpillar track is able to stably receive the driving force without slipping from the driving sprockets.

### CROSS-REFERENCE TO PRIOR APPLICATIONS

This application is a Continuation Application of PCT International Patent Application No. PCT/KR2021/000427 (filed on Jan. 13, 2021), which claims priority to Korean Patent Application No. 10-2020-0009331 (filed on Jan. 23, 2020), which are all hereby incorporated by reference in their entirety.

### BACKGROUND

The present disclosure relates to an amphibious caterpillar vehicle and, more particularly, to an amphibious caterpillar vehicle, which includes a caterpillar track having buoyancy and is drivable on water and land.

The applicant proposed Korean Patent No. 10-0396213 “TRACK-SHOE OF AMPHIBIOUS CATERPILLAR VEHICLES FOR LEISURE” (registered on Aug. 18, 2003), Korean Patent No. 10-1034352 “TRACK-SHOE FOR AMPHIBIOUS CATERPILLAR” (registered on May 3, 2011), Korean Patent No. 10-1598050 “TRACK-SHOE FOR AMPHIBIOUS CATERPILLAR” (registered on Feb. 22, 2016), and Korean Patent No. 10-1954729 “CATERPILLAR VEHICLE FOR DIRECTION CONTROL” (registered on Feb. 27, 2019).

The present disclosure is proposed to improve the above related art.

The conventional amphibious caterpillar vehicle includes a plurality of track shoes connected to each other in a chain form to form a caterpillar track, and the caterpillar track is mounted between a driving sprocket and a passive sprocket and is rotated by a driving force of the driving sprocket.

The driving sprocket includes a track shoe coupling protrusion, which is formed in a tooth shape outward-radially protruding from an edge of the driving sprocket to be inserted into a connected portion between adjacent track shoes to catch and rotate the caterpillar track.

Coupling between the driving sprocket and the caterpillar track and transmission of the driving force are performed only by the track shoe coupling protrusions.

This structure has a problem in that the caterpillar track slips from the driving sprocket or the track shoe coupling protrusion and is damaged when a large driving force is applied to the driving sprocket.

In other words, when a large driving force is applied, a coupling force between the driving sprocket and the caterpillar track is week, and thus a driving force is not efficiently transferred or the track shoe coupling protrusion is damaged due to the driving force.

The above problem is caused by a point in which since the caterpillar track and the driving sprocket of the amphibious caterpillar vehicle are made of a plastic material in a hollow form (or with low density by using foam) so as to generate large buoyancy, the caterpillar track and the driving sprocket are not solidly coupled to each other and a driving force is not stably transferred.

In order to solidly couple the caterpillar track to the driving sprocket to stably transfer the driving force, a protruding size of the track shoe coupling protrusion should be increased and the caterpillar track and the driving sprocket should be made of plastic material in the filled form (or the density of foam is increased). However, in this case, there is a problem in that the weight of the caterpillar track and the driving sprocket are increased to reduce the entire buoyancy.

### SUMMARY

Accordingly, the present disclosure has been made keeping in mind the above problems occurring in the related art, and an objective of the present disclosure is to provide an amphibious caterpillar vehicle configured to increase a coupling force between a track shoe constituting a caterpillar track and a driving sprocket, so that the caterpillar track stably receives a driving force without slipping from the driving sprocket.

In order to accomplish the above objective, the present disclosure is intended to provide an amphibious caterpillar vehicle including a driving sprocket and a passive sprocket that may be rotatably provided at each of front widthwise opposite portions and each of rear widthwise opposite portions of a main body, respectively, and a caterpillar track consisting of a plurality of track shoes connected to each other in a chain form between the driving sprocket and the passive sprocket, wherein each of the track shoes includes a first buoyancy material that may be long in a width direction and be short in a longitudinal direction, a connection plate disposed at an upper surface of the first buoyancy material and including connection brackets at front and rear portions thereof to be coupled to another adjacent connection plate, and a second buoyancy material including a central body and a pair of engagement bodies integrally provided at widthwise opposite portions of the central body and disposed at an upper surface of the connection plate and having a width narrower than a width of the first buoyancy material; the driving sprocket including a pair of wheels disposed to face each other in the width direction and a connection shaft connecting the pair of wheels to each other; each of the wheels has a plurality of buoyancy material engagement grooves formed along a circumference of a surface facing another wheel; and the central body of the second buoyancy material of the track shoe may be disposed between the pair of wheels, and the engagement bodies of the second buoyancy material of the track shoe may be inserted into the buoyancy material engagement grooves of the wheels, so that a driving force may be transferred from the driving sprocket to the caterpillar track.

Each of the track shoes includes a first fixation frame fixing the first buoyancy material to the connection plate and a second fixation frame fixing the second buoyancy material to the connection plate, and a part of the second fixation frame may be inserted into each of the buoyancy material engagement grooves of each of the wheels together with each of the engagement bodies of the second buoyancy material.

The connection plate may have arc-shaped guide portions at front and rear edges thereof in an downward-convex arc shape, and each of the wheels may have a plurality of track shoe coupling protrusions protruding in an outward-radial direction at a main surface of the wheel to be inserted into and locked to the arc-shaped guide portions of the connection plate.

As described above, according to the present disclosure, the amphibious caterpillar vehicle is configured to increase a coupling force between the track shoe constituting the caterpillar track and the driving sprocket, so that the caterpillar track can stably receive the driving force without slipping from the driving sprocket.

In addition, the amphibious caterpillar vehicle is configured to increase a coupled area between the track shoe and the driving sprocket, so that when a strong driving force is applied, it is possible to prevent the track shoe or the driving sprocket from being damaged by pressure distribution.

### BRIEF DESCRIPTION OF THE DRAWINGS

FIG. 1 is a concept plan view showing an amphibious caterpillar vehicle according to an embodiment of the present disclosure;

FIG. 2 is a concept side view showing a coupling state of sprockets and a caterpillar track of the amphibious caterpillar vehicle shown in FIG. 1;

FIG. 3 is a perspective view showing a track shoe of the amphibious caterpillar vehicle shown in FIG. 1;

FIG. 4 is a perspective view showing an exploded-perspective view showing the track shoe shown in FIG. 3;

FIG. 5 is a concept sectional view showing the track shoe shown in FIG. 3;

FIG. 6 is a perspective view showing a connected state of connection plates in FIG. 4;

FIG. 7 is a plan view showing a wheel shown in FIG. 1;

FIG. 8 is a side view showing the wheel shown in FIG. 7;

FIG. 9 is a perspective view showing the wheel shown in FIG. 7;

FIGS. 10 to 12 are views showing a coupled state of a wheel of a driving sprocket and the track shoe in FIG. 1;

FIG. 13 is a side view showing a wheel of the amphibious caterpillar vehicle according to another embodiment of the present disclosure;

FIG. 14 is a perspective view of FIG. 13; and

FIG. 15 is a concept view showing a coupled state of the wheel and the caterpillar track in FIG. 13.

### DETAILED DESCRIPTION

Hereinbelow, exemplary embodiments of the present disclosure will be described in detail with reference to the accompanying drawings such that the invention can be easily embodied by one of ordinary skill in the art to which the present disclosure belongs. However, the present disclosure may be embodied variously and is not limited to the embodiment described hereinbelow. Throughout the drawings, components incorporated herein will be omitted when it may make the subject matter of the present disclosure unclear, the same reference numerals will refer to the same or like parts. Unless the context clearly indicates otherwise, it will be further understood that the terms “comprises”, “comprising”, “includes”, and/or “including”, when used herein, specify the presence of stated components, but do not preclude the presence or addition of one or more other components.

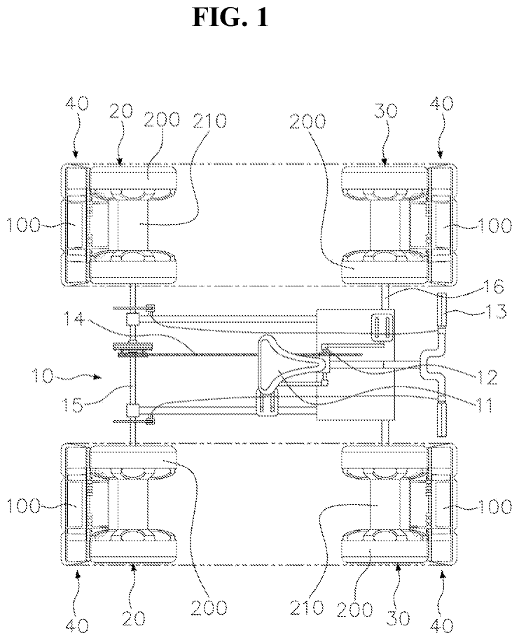

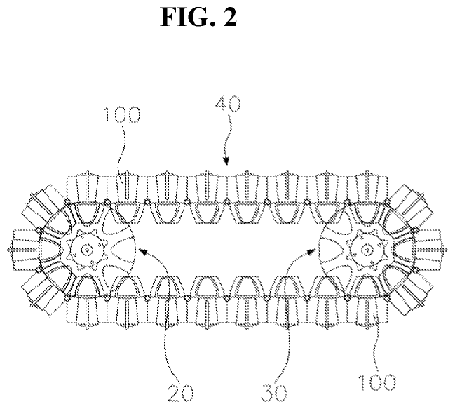

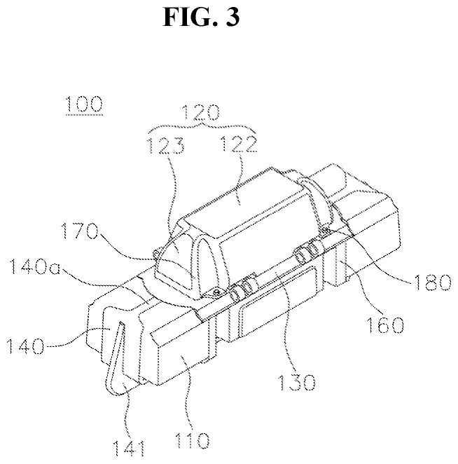

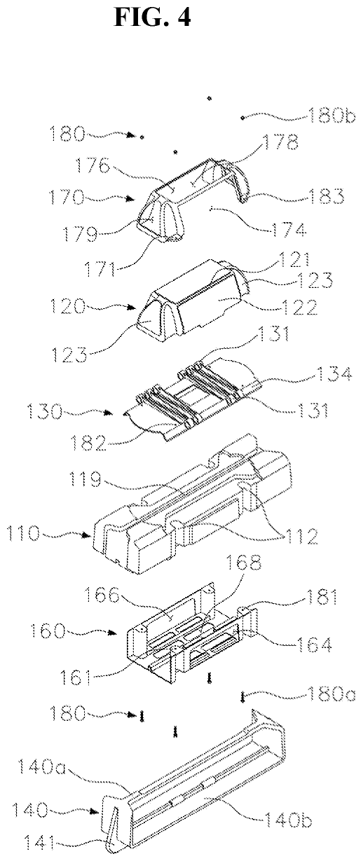

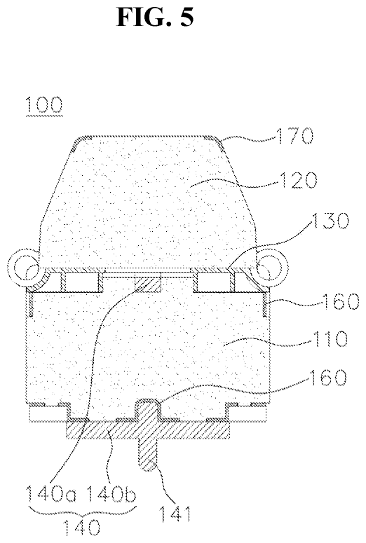

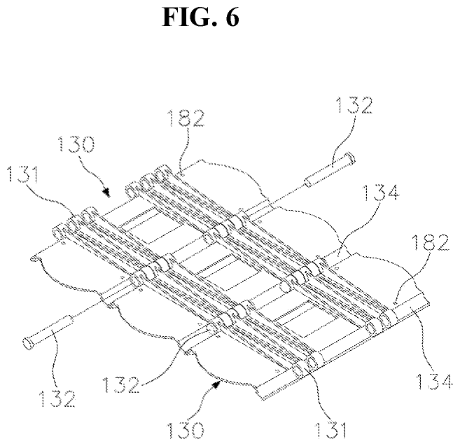

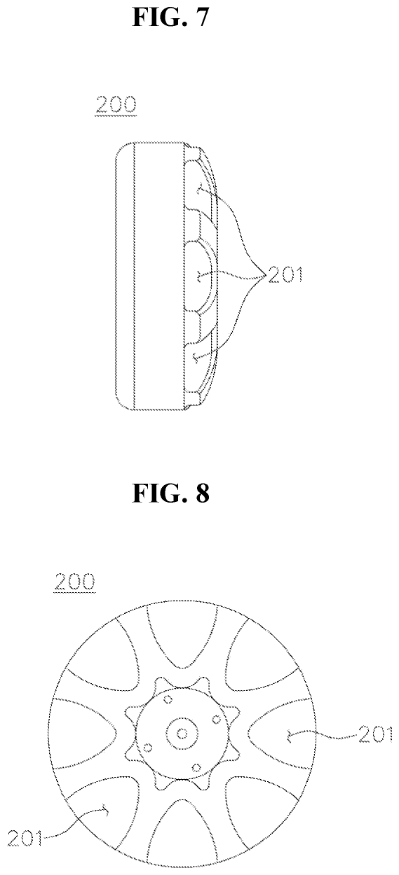

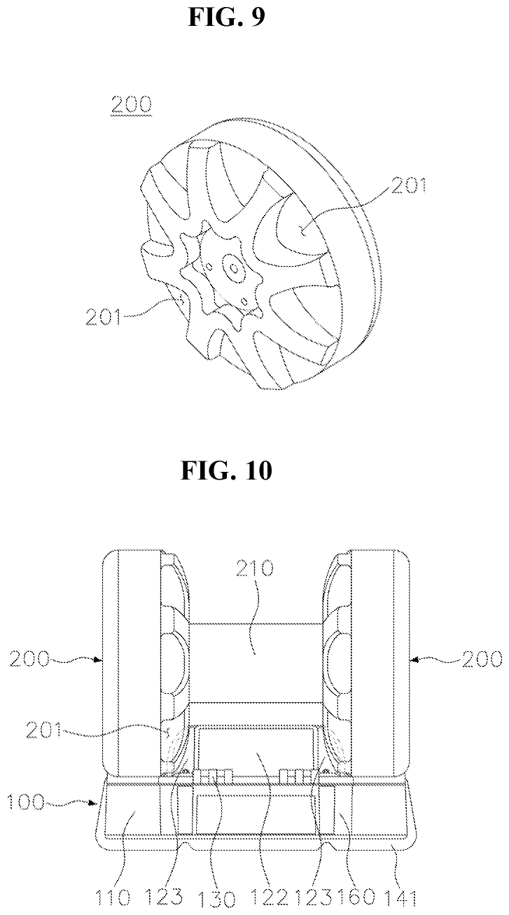

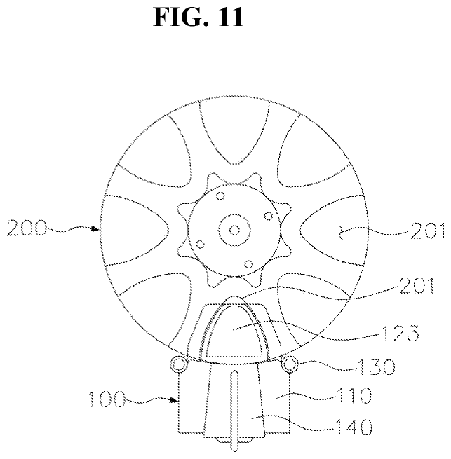

FIG. 1 is a concept plan view showing an amphibious caterpillar vehicle according to an embodiment of the present disclosure. FIG. 2 is a concept side view showing a coupling state of sprockets and a caterpillar track of the amphibious caterpillar vehicle shown in FIG. 1. FIG. 3 is a perspective view showing a track shoe of the amphibious caterpillar vehicle shown in FIG. 1. FIG. 4 is a perspective view showing an exploded-perspective view showing the track shoe shown in FIG. 3. FIG. 5 is a concept sectional view showing the track shoe shown in FIG. 3. FIG. 6 is a perspective view showing a connected state of connection plates in FIG. 4. FIG. 7 is a plan view showing a wheel shown in FIG. 1. FIG. 8 is a side view showing the wheel shown in FIG. 7. FIG. 9 is a perspective view showing the wheel shown in FIG. 7. FIG. 10 to are views showing a coupled state of a wheel of a driving sprocket and the track shoe in FIG. 1.

According to an embodiment of the present disclosure, as shown in FIGS. 1 and 2, an amphibious caterpillar vehicle includes a ride-on main body 10, driving sprockets 20 and passive sprockets 30 rotatably provided at front and rear opposite portions of the main body 10, respectively, and a caterpillar track 40 including a plurality of track shoes 100 connected to each other in a chain form and mounted between one of the driving sprockets 20 and one of the passive sprockets 30.

The amphibious caterpillar vehicle according to the embodiment is manufactured for a person to directly board. The main body 10 includes a seating part 11 having a bicycle saddle shape, so that an occupant can sit thereon.

A driving part 12 is provided in the main body 10 to generate a driving force. The driving part 12 may be a power generating device such as a motor or an engine. The driving part of the embodiment is a manual driving part 12, so that the occupant directly generates a driving force. The manual driving part 12 has a bicycle-type pedal structure widely used in bicycles.

The main body 10 includes a grip 13 by being held by a hand of the occupant in addition to the seating part 11 and the manual driving part 12. As shown in the drawings, the grip 13 has a form similar to a bicycle grip. However, unlike the bicycle grip, the grip 13 is fixed to prevent transverse rotation thereof.

A driving force generated by the manual driving part 12 is transferred to a driving shaft 15 through a chain 14 to rotate the driving sprockets 20 provided at opposite ends of the driving shaft 15.

The driving shaft 15 is arranged in a width direction of the main body 10, and the main body 10 includes a passive shaft 16 in parallel with the driving shaft 15. The driving sprockets 20 are coupled to the opposite ends of the driving shaft 15, and the passive sprockets 30 are provided at opposite ends of the passive shaft 16.

As described above, the structure of the main body 10 including the manual driving part 12, the grip 13, the chain 14, the driving shaft 15, and the passive shaft 16 was already proposed in Korean Patent No. 10-1954729 of the applicant. Korean Patent No. 10-1954729 is integrated in the specification, and the detailed structure of the main body 10 and generation and steering methods of a driving force will be described herein.

In addition, the present disclosure may be applied to an amphibious caterpillar vehicle having a power generation device, such as a motor or engine, as a driving part.

The driving sprockets 20 and the passive sprockets 30 are provided at the front and rear widthwise opposite portions of the main body 10. The caterpillar track 40 is mounted between each of the driving sprockets 20 and each of the passive sprockets 30.

The caterpillar track 40 has a structure in which the plurality of track shoes 100 are connected to each other in the chain form. The caterpillar track 40 is rotated by receiving a driving force of the driving sprocket 20 and allows the main body 10 to move forward in a rotating direction of the driving sprocket 20.

According to the embodiment, each of the driving sprockets 20 and each of the passive sprockets 30 have the same structure, so only the driving sprocket 20 will be described below and the description of the passive sprocket 30 will be omitted.

In the specification, “width direction” of the track shoe is the same as the width direction of the amphibious caterpillar vehicle, and “vertical direction and longitudinal direction” of the track shoe are based on a posture of the track shoe 100 shown in FIG. 3.

The plurality of track shoes 100 in the embodiment are connected to each other to form the caterpillar track 40, and all the track shoes 100 are formed in the same shape.

The track shoes 100 includes a first buoyancy material 110, a second buoyancy material 120, a connection plate 130, a foam pad 140, a first fixation frame 160, a second fixation frame 170, and a coupling member 180.

The connection plate 130, the first fixation frame 160, and the second fixation frame 170 are made of hard plastic. The first buoyancy material 110 and the second buoyancy material 120 are made of foam to generate buoyancy. The foam pad 140 is made of foam to reduce an impact transferred from the ground.

The first buoyancy material 110 has a hexahedral shape that is long widthwise and is short longitudinally.

First fixation grooves 112 are formed by being recessed on both a front surface and a rear surface of the first buoyancy material 110.

Two first fixation grooves 112 are formed on each of the front surface and the rear surface of the first buoyancy material 110 while being spaced apart from each other.

In order to fix the first buoyancy material 110 to the connection plate 130 to be described later, the first fixation frame 160 is provided.

The first fixation frame 160 is mounted to the first buoyancy material 110 in close contact with the first fixation grooves 112 formed in the first buoyancy material 110.

The first fixation frame 160 is formed in a ‘⊂’-shaped box that is open toward the upper side, so that an upper surface and widthwise opposite surfaces thereof are open.

The first fixation frame 160 is in close contact with front, rear, and lower surfaces of the first buoyancy material 110.

The width of the first fixation frame 160 is narrower than the width of the first buoyancy material 110.

The first fixation frame 160 has a first front opening 164 exposing the front surface of the first buoyancy material 110, a first rear opening 166 exposing the rear surface of the first buoyancy material 110, and a plurality of lower openings 168 exposing the lower surface of the first buoyancy material 110. These openings serve to reduce the weight of the first fixation frame 160 to generate more buoyancy.

Four first support plates 161 are horizontally provided on upper ends of the first fixation frame 160.

Each of the first support plates 161 of the first fixation frame 160 has a first through hole 181 for bolting.

Furthermore, an empty portion is formed below the first support plate 161, so that the bolt 180a may move vertically, when a bolt 180a of the coupling member 180 performs bolting through the first through hole 181 of the first support plate 161.

Meanwhile, downward-depressed grooves are formed on an upper surface and a lower surface of the first buoyancy material 110 by being extended in the width direction, and the grooves extended in the width direction pass through the longitudinal center of the first buoyancy material 110. In addition, inward-recessed rectangular grooves are formed on opposite lateral surfaces of the first buoyancy material 110.

As described above, the grooves formed on the upper, lower, opposite lateral surfaces of the first buoyancy material 110 are pad-coupling grooves 119, and the pad-coupling grooves 119 are connected to each other while surrounding the first buoyancy material 110.

Herein, the first fixation frame 160 in close contact with the lower surface of the first buoyancy material 110 is also in close contact with the lower pad-coupling groove 119 formed on the lower surface of the first buoyancy material 110.

The foam pad 140 is mounted to the first buoyancy material 110 by using the pad-coupling grooves 119 of the first buoyancy material 110, which are formed as described above.

The foam pad 140 is coupled to the pad-coupling grooves 119 formed in the first buoyancy material 110 and surrounds the first buoyancy material 110.

The foam pad 140 includes a buoyancy material coupling part 140a and a bottom plate 140b.

The buoyancy material coupling part 140a of the foam pad 140 has a rectangular ring shape. In other words, upper and opposite lateral portions of the buoyancy material coupling part 140a are inserted into the pad-coupling grooves 119 formed on the upper and opposite later surfaces of the first buoyancy material 110. A lower portion of the buoyancy material coupling part 140a is inserted into the lower portion of the first fixation frame 160 inserted in the pad-coupling groove 119 formed on the lower surface of the first buoyancy material 110.

The bottom plate 140b is formed in a lower portion of the buoyancy material coupling part 140a.

The bottom plate 140b is extended horizontally and covers the lower surface of the first buoyancy material 110.

The width of the bottom plate 140b corresponds to the width of the first buoyancy material 110, and the longitudinal length of the bottom plate 140b is shorter than the longitudinal of the first buoyancy material 110.

The bottom plate 140b as foam may absorb an external impact.

In other words, when the caterpillar vehicle moves on land, the foam pad 140 protects the track shoes 100 from an external impact.

A webbed protrusion 141 is formed on a lower surface of the foam pad 140.

The webbed protrusion 141 protrudes downward.

The webbed protrusion 141 is extended along the longitudinal center of the bottom plate 140b, and is extended lengthily to opposite lateral surfaces of the bottom plate 140b.

When the caterpillar vehicle moves in water, the webbed protrusion 141 pushes water in the opposite direction to a moving direction of the caterpillar vehicle. In other words, by the principle of action and reaction, the webbed protrusion 141 increases an in-water moving speed of the caterpillar vehicle.

The connection plate 130 is disposed on the upper surface of the first buoyancy material 110. The connection plate 130 couples the first buoyancy material 110 to the second buoyancy material 120, which will be described below, and connects the track shoes 100 to each other in the chain form.

The connection plate 130 has the width narrower than the width of the first buoyancy material 110, and has the longitudinal length corresponding to the longitudinal length of the first buoyancy material 110.

The connection plate 130 has a second through hole 182 corresponding to the first through hole 181 formed in the first support plate 161 of the first fixation frame 160.

A plurality of connection brackets 131 are provided at front and rear portions of the connection plate 130, respectively.

Each of the connection brackets 131 of the connection plate 130 intersects with adjacent connection brackets 131 of the connection plate 130 (referring to FIG. 6). A connecting member 132 is inserted into in a space where the adjacent connection brackets 131 intersect and are coupled to each other, so that adjacent connection plates 130 are rotatably connected to each other. By the above-described method, the adjacent track shoes 100 are rotatably connected to each other to provide the caterpillar track 40.

Furthermore, arc-shaped guide portions 134 with a downward convex arc shape are formed at front and rear edges of the connection plate 130.

Each of the arc-shaped guide portions 134 limits a rotational range between the adjacent track shoes 100.

When the connection plate 130 is connected to another adjacent connection plate 130, adjacent arc-shaped guide portions 134 are brought into contact with each other to form a semi-circular structure.

According to another embodiment, the semi-circular structure formed by the adjacent arc-shaped guide portions 134 may be used to be coupled to track shoe coupling protrusions 202 of each of wheels 200 of the driving sprocket 20.

The second buoyancy material 120 is arranged on an upper portion of the first buoyancy material 110, more specifically, on an upper surface of the connection plate 130.

The second buoyancy material 120 is made of foam and also generates buoyancy like the first buoyancy material 110.

The longitudinal length of the second buoyancy material 120 is shorter than the longitudinal length of the first buoyancy material 110 and the width of the second buoyancy material 120 is narrower than the width of the first buoyancy material 110.

The second buoyancy material 120 includes a cuboid central body 122 and a pair of engagement bodies 123 integrally formed at widthwise opposite portions of the central body 122.

Each of the engagement bodies 123 has a triangular shape convexly protruding in widthwise outward directions.

Second fixation grooves 121 are formed on a surface of the second buoyancy material 120 while being connected to each other along corners of the second buoyancy material 120.

In other words, a rectangular groove is formed along edges of an upper surface of the central body 122, and also grooves are formed on four corners extended downward from the edges of the upper surface the central body 122.

Furthermore, grooves are formed by being vertically extended along the engagement bodies 123, and grooves are formed by being extended along a bottom surface of the engagement bodies 123.

The engagement bodies 123 are inserted into and engaged with the driving sprockets 20.

The shape of the engagement bodies 123 in a side view is a triangular shape of which the width is gradually reduced in an upward direction.

As described above, the shape of each of the engagement bodies 123 is formed such that the engagement body 123 is easily inserted into and separated from a buoyancy material engagement groove 201 of the driving sprocket 20, and when being fully inserted therein, the engagement body 123 is solidly fixed to the buoyancy material engagement groove 201 without slipping.

The shape of the buoyancy material engagement groove 201 corresponding to the shape of the engagement body 123 will be described in detail below.

The second fixation frame 170 is provided to fix the second buoyancy material 120 to the connection plate 130.

The second fixation frame 170 is formed in a rectangular table with an open upper portion. The second fixation frame 170 is coupled to the second buoyancy material 120 by being inserted into the second fixation grooves 121.

The second fixation frame 170 includes a second front opening 174 exposing a front surface of the second buoyancy material 120, a second rear opening 176 exposing a rear surface of the second buoyancy material 120, and an upper opening 178 exposing an upper surface of the second buoyancy material 120. In addition, the second fixation frame 170 includes side openings 179 at opposite portions in the width direction to expose side surfaces of the engagement bodies 123.

These openings reduce the weight of the second fixation frame 170 and serve to generate buoyancy by increasing the space occupied by the second buoyancy material 120.

Second support plates 171 are provided at four lower corners of the second fixation frame 170 in the horizontal direction to correspond to the first support plates 161 of the first fixation frame 160.

The second support plates 171 of the second fixation frame 170 respectively have third through holes 183 for bolting.

Each of the third through holes 183 is formed to correspond to the first through hole 181 and the second through hole 182.

Furthermore, when the nut 180b of the coupling member 180 performs bolting through the third through hole 183 of the second support plate 171, an empty portion is provided above the second support plates 171 so as to allow the nut 180b to vertically move.

The coupling member 180 is a member to connect the first fixation frame 160, the connection plate 130, and the second fixation frame 170 to each other.

According to the embodiment, the coupling member 180 includes the bolt 180a and a nut 180b, and the bolt 180a and the nut 180b bolt to each other.

The first through hole 181 of the first support plate 161, the second through hole 182 of the connection plate 130, and the third through hole 183 of the second support plates 171 are formed to correspond to each other in position.

In other words, when the first support plates 161 of the first fixation frame 160, the connection plate 130, and the second support plates 171 of the second fixation frame 170 are in close contact with each other, the first through holes 181, the second through holes 182, and the third through holes 183 are arranged in a line.

As described above, the nut 180b is coupled to the bolt 180a of the coupling member 180 passing through each of the first through hole 181, each of the second through hole 182, and each of the third through holes 183 by bolting, so that the first support plates 161 of the first fixation frame 160 and the second support plates 171 of the second fixation frame 170 are prevented from being separated from the connection plate 130.

Furthermore, the first buoyancy material 110 in close contact with the first fixation frame 160 and the second buoyancy material 120 in close contact with the second fixation frame 170 are prevented from being separated from the connection plate 130.

Hereinbelow, the driving sprockets 20 and the passive sprockets 30 will be described. According to the embodiment, the passive sprockets 30 are the same as the driving sprockets 20, so only the driving sprockets 20 will be described below.

The driving sprockets 20 are manufactured in blow molding method using conventional plastic.

Each of the driving sprockets 20 of the embodiment includes a pair of wheels 200 arranged to face each other in the width direction, and a connection shaft 210 connecting the pair of wheels 200 to each other (referring to FIG. 10).

Each of the wheels 200 has a plurality of buoyancy material engagement grooves 201 formed along an edge of a facing surface of another wheel 200.

The buoyancy material engagement grooves 201 of the wheels 200 are provided for insertion and locking of the engagement bodies 123 of the second buoyancy material 120. Each of the buoyancy material engagement grooves 201 is formed in a triangular shape, which is concave radially inward, on one surface of one of the wheels 200 (surface facing another wheel) so as to correspond to the shape of each of the engagement bodies 123.

The pair of wheels 200 are arranged to be spaced apart from each other so that facing surfaces of the wheels 200 face each other, and the pair of wheels 200 are coupled to each other through the connection shaft 210 and are fixed to each other.

The second buoyancy material 120 of the track shoe 100 is located between the pair of wheels 200 and, more particularly, the central body 122 of the second buoyancy material 120 of the track shoe 100 is arranged between the pair of wheels 200 and the engagement body 123 of the second buoyancy material 120 of the track shoe 100 are inserted into and locked in the buoyancy material engagement groove 201 of the wheel 200.

Furthermore, a part of the second fixation frame 170 of the track shoe 100 is inserted into the buoyancy material engagement groove 201 of the wheel 200 together with the engagement body 123.

Meanwhile, an outer circumferential surface of the wheel 200 is brought into contact with the upper surface of the first buoyancy material 110 to support the first buoyancy material 110.

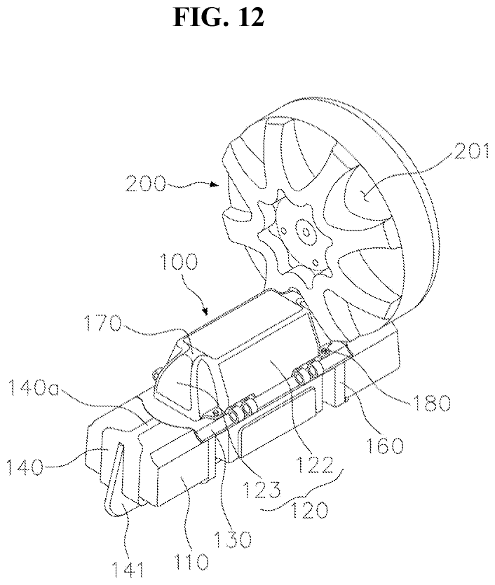

The structure in which the second buoyancy material 120 of the track shoe 100 is locked in the buoyancy material engagement groove 201 of the wheel 200 and the first buoyancy material 110 of the track shoe 100 is supported by the outer circumferential surface of the wheels 200 is shown in FIGS. 10 and 12.

Hereinbelow, another embodiment of the present disclosure will be described.

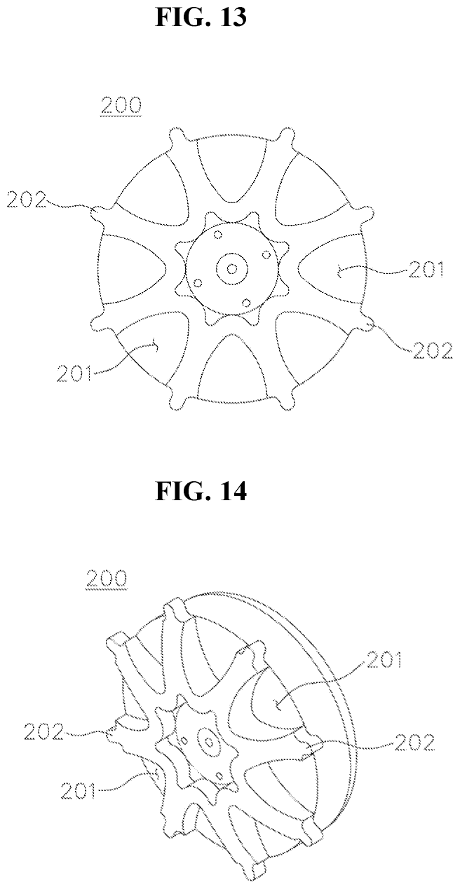

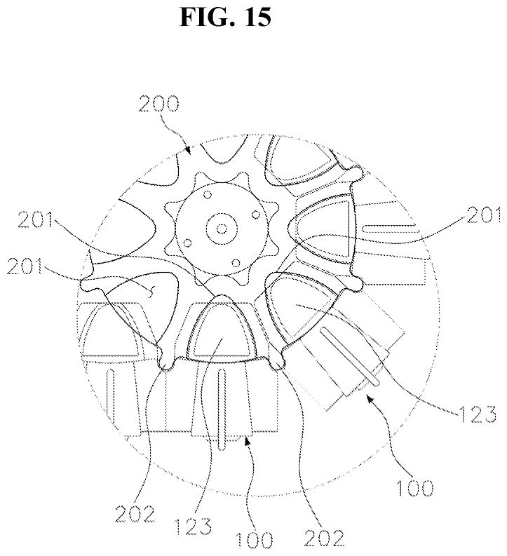

FIG. 13 is a side view showing a wheel of the amphibious caterpillar vehicle according to the another embodiment of the present disclosure. FIG. 14 is a perspective view of FIG. 13. FIG. 15 is a concept view showing a coupled state of the wheel and the caterpillar track in FIG. 13.

Each of the track shoe coupling protrusions 202 may be formed on a circumference of a main surface of each of the wheels 200 to be inserted into and engaged with a connection portion between the track shoes 100 (specifically, a portion between adjacent two connection plate 130). The track shoe coupling protrusion 202 is formed by protruding radially outward from the circumference of the main surface of each of the wheels 200.

Each of the track shoe coupling protrusion 202 is inserted into and locked between the two adjacent track shoes 100, more specifically, in a semi-circular structure formed by the arc-shaped guide portions 134 of the adjacent connection plates 130.

The track shoe coupling protrusions 202 may increase a coupling force between the driving sprocket 20 and the caterpillar track 40.

When the engagement bodies 123 and the buoyancy material engagement grooves 201 are provided to couple the second buoyancy material 120 to the wheels 200, the track shoe coupling protrusions 202 are provided to couple the connection plate 130 to the wheels 200.

In other words, as a driving force may be transferred by coupling the two parts without interference, more solidly and stably engagement structure is secured.

The track shoe coupling protrusion 202 is inserted into and engaged in the semi-circular structure formed by the arc-shaped guide portions 134 of the adjacent connection plates 130, so that dual engagement structure is complete with the engagement bodies 123 and the buoyancy material engagement grooves 201. Therefore, a coupling force of the caterpillar track 40 and the driving sprocket 20 is increased and a driving force is more stably transferred.

In FIG. 15, although it is not possible to directly confirm the arc-shaped guide portions 134 and the semi-circular structure thereof, a corner portion of the first buoyancy material 110 widthwise extended in the same shape as each of the arc-shaped guide portions 134. Therefore, it is possible to confirm the form in which each of the track shoe coupling protrusions 202 is inserted into and engaged in the semi-circular structure of the arc-shaped guide portions 134.

Although the preferred embodiments of the present disclosure have been described for illustrative purposes, and those skilled in the art will appreciate that various modifications, additions and substitutions are possible, without departing from the scope and of the present disclosure as disclosed in the accompanying claims.

Therefore, it should be understood that the embodiments are not limited to the description hereinabove. For example, each element described in a single form may be embodied in a dispersed form, and components described as being dispersed herein may be embodied in a coupled form.

The scope of the present disclosure is defined by the accompanying claims rather than the description which is presented above. Moreover, the present disclosure is intended to cover not only the exemplary embodiments, but also various alternatives, modifications, equivalents and other embodiments that may be included within the spirit and scope of the present disclosure as defined by the appended claims.

The present disclosure may be used as the amphibious caterpillar vehicle that can drive on water or land.

What is claimed is:

1. An amphibious caterpillar vehicle comprising:
a driving sprocket and a passive sprocket that are rotatably provided at each of front widthwise opposite portions and each of rear widthwise opposite portions of a main body, respectively, and a caterpillar track consisting of a plurality of track shoes connected to each other in a chain form between the driving sprocket and the passive sprocket,
wherein each of the track shoes comprises a first buoyancy material that is long in a width direction and is short in a longitudinal direction, a connection plate disposed at an upper surface of the first buoyancy material and comprising connection brackets at front and rear portions thereof to be coupled to another adjacent connection plate, and a second buoyancy material comprising a central body and a pair of engagement bodies integrally provided at widthwise opposite portions of the central body and disposed at an upper surface of the connection plate and having a width narrower than a width of the first buoyancy material;
the driving sprocket comprises a pair of wheels disposed to face each other in the width direction and a connection shaft connecting the pair of wheels to each other; each of the wheels has a plurality of buoyancy material engagement grooves formed along a circumference of a surface facing another wheel; and
the central body of the second buoyancy material of the track shoe is disposed between the pair of wheels, and the engagement bodies of the second buoyancy material of the track shoe are inserted into the buoyancy material engagement grooves of the wheels, so that a driving force is transferred from the driving sprocket to the caterpillar track.

2. The amphibious caterpillar vehicle of claim 1, wherein each of the track shoes comprises a first fixation frame fixing the first buoyancy material to the connection plate and a second fixation frame fixing the second buoyancy material to the connection plate, and
a part of the second fixation frame is inserted into each of the buoyancy material engagement grooves of each of the wheels together with each of the engagement bodies of the second buoyancy material.

3. The amphibious caterpillar vehicle of claim 1, wherein the connection plate has arc-shaped guide portions at front and rear edges thereof in an downward-convex arc shape, and each of the wheels has a plurality of track shoe coupling protrusions protruding in an outward-radial direction at a main surface of the wheel to be inserted into and locked to the arc-shaped guide portions of the connection plate.
